(19) United States
(12) Patent Application Publication
(10) Pub. No.: US 2011/0252405 A1
(43) Pub. Date: Oct. 13, 2011

(54) DETECTING USER INTERFACE DEFECTS IN A SOFTWARE APPLICATION

(76) Inventors: Ilan Meirman, Petah-Tikwa (IL); Roy Nuriel, Tel Aviv (IL); Yossi Rachelson, Petach Tikwa (IL); Dekel Tal, Rehovot (IL)

(21) Appl. No.: 12/757,993

(22) Filed: Apr. 10, 2010

(51) Int. Cl. G06F 9/44

(52) U.S. Cl. 717/125

(57) ABSTRACT

One embodiment is a method that displays an inspection tool and output generated by a software application being tested for defects. The method detects a defect in a user interface of the output of the software application and generates an annotation of the defect.

### BACKGROUND

During the development and testing of a software application, software testers examine the application for defects, such as quality issues associated with the user interface. A manual examination of the application for user interface defects is difficult and in some cases not possible. Moreover, tools to detect such issues can disrupt the testing process and be time consuming for the software tester.

### BRIEF DESCRIPTION OF THE DRAWINGS

FIG. 1 shows a flow diagram for detecting defects in a software application in accordance with an example embodiment.

FIG. 2A shows a display with a software application and a set of tools for detecting defects in the software application in accordance with an example embodiment.

FIG. 2B shows a ruler tool for detecting defects in a software application in accordance with an example embodiment.

FIG. 2C shows a guide tool for detecting defects in a software application in accordance with an example embodiment.

FIG. 2D shows a color picker tool for detecting defects in a software application in accordance with an example embodiment.

FIG. 3 shows a computer system in accordance with an example embodiment.

### DETAILED DESCRIPTION

Example embodiments relate to apparatus and methods that detect defects in a software application and report such defects to a defect tracking system.

During the development or testing of a software application, a software tester can open an inspection surface that displays on an electronic device (such as a computer) a current output or screen of the software application being tested. The inspection surface provides a set of inspection tools that assist the software tester in analyzing the current screen for defects and quality issues. The inspection tools enable the software tester to examine the software application for defects, such as quality issues associated with the user interface (UI). For example, one aspect of the quality of the user interface is how well texts and images are arranged and displayed in windows of the software application (e.g., examine the software application for consistency in colors of objects, alignment of images, spacing between images, consistent usage of size and font of text, etc.).

Once a defect is detected, example embodiments enable the software tester to annotate the defect with various on-screen indicators and then save and report or transmit the defect and annotations to a defect tracking system and/or software developer or programmer. The report automatically includes a screenshot of the software application where the defect occurred along with the annotations indicating the UI defect. When the software tester finishes analyzing a current screen, the inspection surface is closed, and the software tester continues testing further portions of the software application.

In one example embodiment, a software tester can both detect and report UI defects during the testing process directly from the manual tester application. The detecting and reporting are both accomplished without accessing any external software.

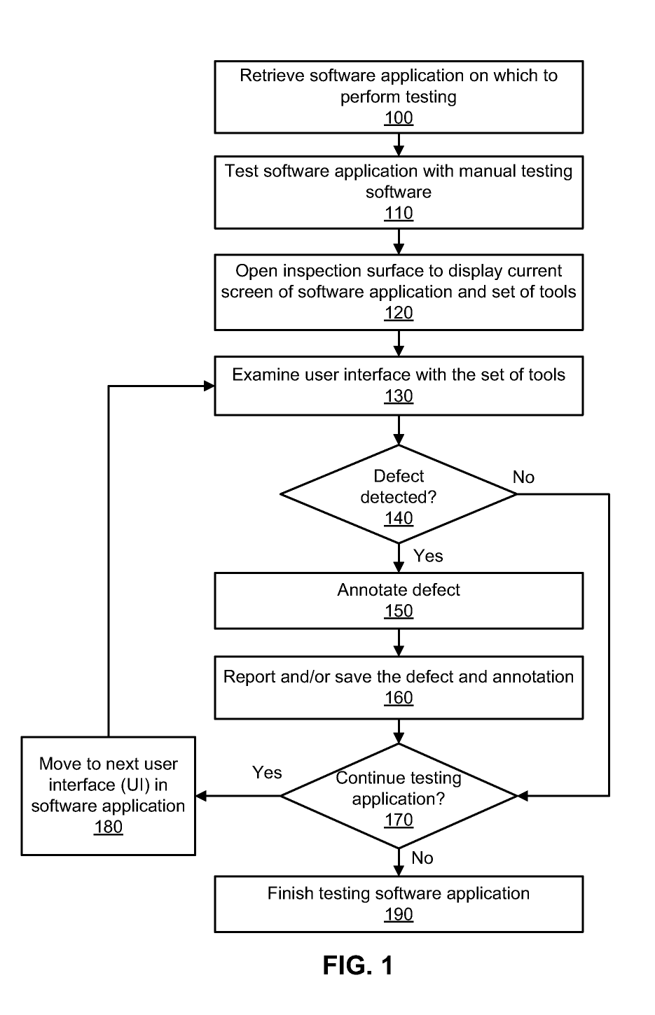

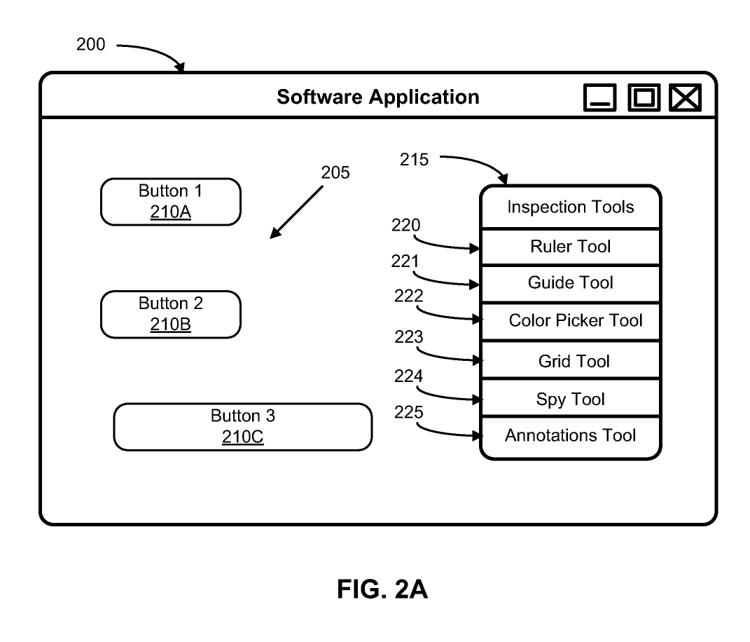

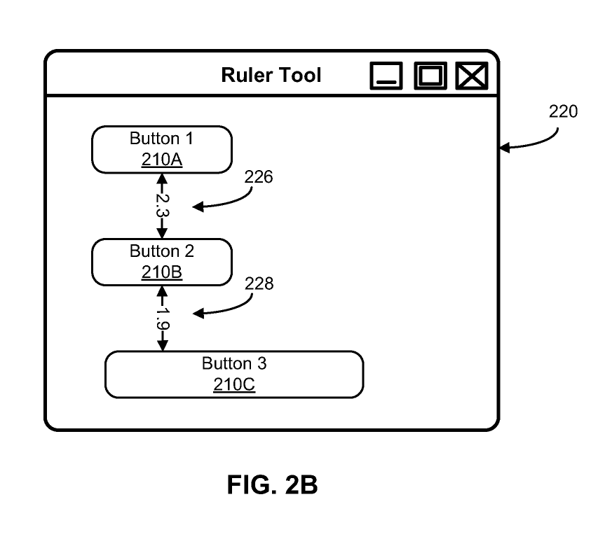

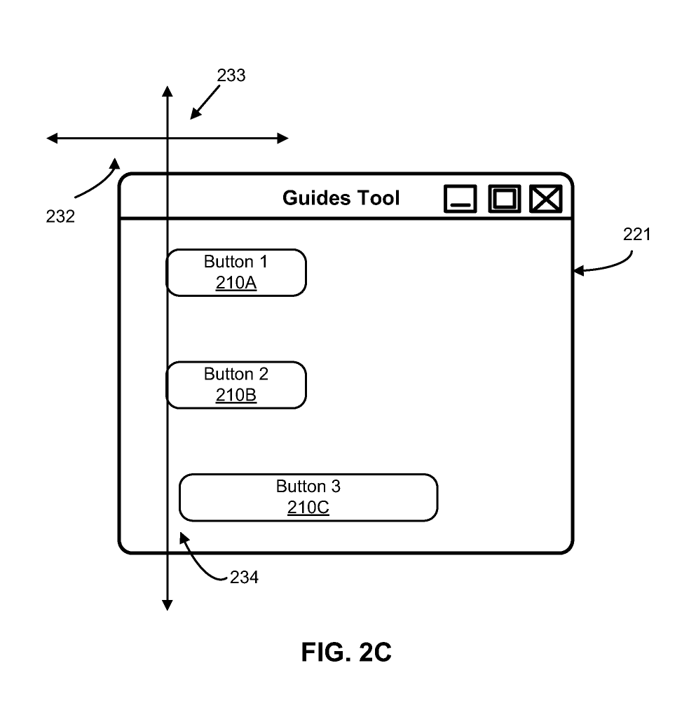

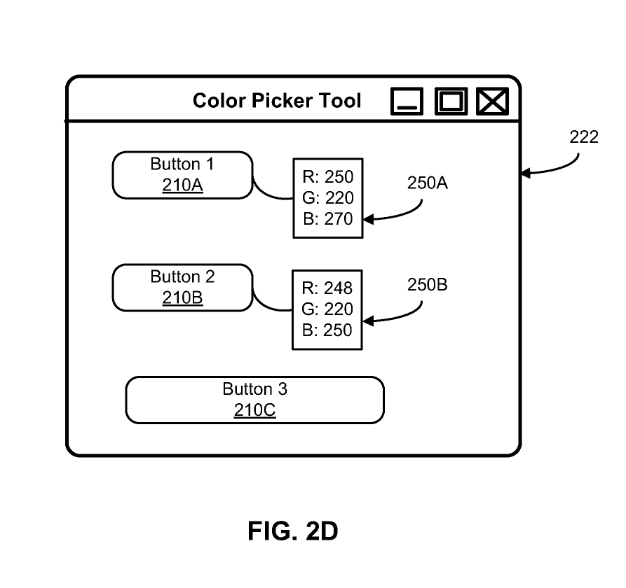

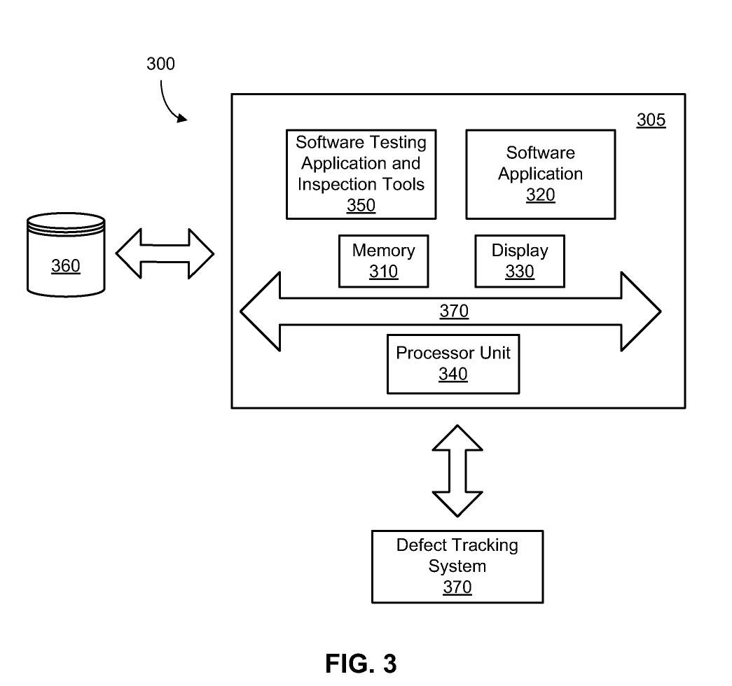

FIG. 1 shows a flow diagram for detecting defects in a software application in accordance with an example embodiment. FIG. 1 is discussed in connection with FIGS. 2A-2D and 3.

According to block 100, the software application is retrieved on which to perform testing. For example, the software application is retrieved or received from memory, a storage location, a network location, etc. (e.g., software application 320 in FIG. 3 is obtained from memory 310 or storage location 360).

According to block 110, the software application is tested with manual testing application. The manual testing application enables a user (such as a software tester) to test the software application for defects, such as UI defects or defects appearing on a graphical user interface (GUI). As the software application executes, different pages, outputs, windows, etc. are displayed to the software tester.

As shown in FIG. 3 for example, the software tester opens the software application 320 and software testing application and inspection tools 350 to begin testing pages, outputs, UIs, graphical user interfaces (GUIs), etc. of the software application being executed.

According to block 120, an inspection surface is opened to display a current screen of the software application and a set of tools. By way of example, the inspection surface includes, but is not limited to, a window, a box, or other graphical and textual output on a display or screen.

FIG. 2A shows a display 200 with a current user interface or output 205 of a software application being executed and examined for defects. The user interface includes a plurality of buttons 210A, 210B, and 210C being displayed on display 200. These buttons include, but are not limited to, controls, labels, images, text, visual outputs from a software application, web page, etc.

As used herein and in the claims, a control is an interactive user interface element. Controls include, but are not limited to, an input box, check box, radio button, drop down list (combo box), button, etc. displayed on a computer or electronic device.

As used herein and in the claims, a user interface or UI is a system by which a user interacts with an electronic device (e.g., a computer). The user interface includes hardware (physical) and software (logical) components to enable the user to provide input to the system and/or allow the system to output effects of user manipulations.

A set of tools 215 is opened and displayed for detecting defects in the software application in accordance with an example embodiment. The tools are used to detect different types of errors or defects in the software application. By way of example, the set of tools 215 includes, but is not limited to, one or more of a ruler tool 220, a guide tool 221, a color picker tool 222, a grid tool 223, a spy tool 224, and an annotations tool 225.

According to block 130, the user interface of the software application is examined with the set of tools. The software tester uses the set of tools 215 to examine the software application for errors or defects in the UI or GUI of the software application. As explained below, various measurements and calculations are made with the tools.

Example embodiments enable the software tester to visually detect and then report defects in the user interface during execution and testing of the software application directly from the manual testing software. While performing software testing using the manual testing software, the current screen of the software application is displayed to the user.

According to block 140, a determination is made as to whether a defect is detected.

FIG. 2B shows a ruler tool 220 for detecting defects in a software application in accordance with an example embodiment. The ruler tool 220 enables the software tester to measure distance between points on the screen. Such measurements are used to determine if the distances between controls in the user interface are consistent or as intended by the software programmer.

In one embodiment, the user selects the ruler tool 220 from a toolbox or set of tools 215 (shown in FIG. 2A) and clicks and drags the tool on the surface between the two points being measured. While being dragged, the ruler tool displays a line between a starting point and a current or ending point, and the distance between the two points is displayed in pixels or another measurement (e.g., millimeters, inches, etc.). When the mouse button is released, the ruler line remains on the surface and displays the distance between the two points in the center or another location on the screen. For example, a first mouse click generates the starting point for the ruler, and a second mouse click (or release of the mouse click) generates the ending point for the ruler.

The ruler line can be deleted from the surface if needed. Furthermore, the ruler line appears in a screenshot as an annotation that is included in the reporting options described herein (report a defect, send an email, etc.). This assists the software tester in communicating defects to third parties, such as the programmers or developers of the software application.

In one example embodiment, the ruler tool locks the ruler line along horizontal or vertical axes of the display while the user drags the tool. This behavior assists the software tester in measuring distances along one of the axes (e.g., X-axis or Y-axis of the display screen). Diagonal distances are also measured (e.g., the software tester presses the shift button while dragging the mouse to release the axis lock feature).

To assist the software tester in accurately measuring the distance between two user interface elements, the ruler tool snaps on to each element, object, or control. While the tool is being dragged, the distance between the starting point and the cursor location continuously changes and is displayed above the cursor. When the mouse button is released, the final distance is displayed in the middle of the ruler or at another location on the display.

By way of example, FIG. 2B shows that the distance 226 between button 210A and button 210B (being shown as 2.3) is not equal to the distance 228 between button 210B and button 210C (being shown as 1.9). Thus, the software tester is able to visually determine with the ruler tool that the distance between the buttons is not consistent or equivalent.

FIG. 2C shows a guide tool 221 for detecting defects in a software application in accordance with an example embodiment. The guide tool 221 enables the software tester to examine whether elements in the screen of the software application being tested are aligned with each other.

To use the guide tool, the software tester selects it from the toolbox and moves the cursor on the screen to the area of the controls being examined. While moving the cursor, vertical and horizontal guide lines 232 are displayed along the length and width of the screen with their intersection under the cursor (crosshair 233). When the software tester clicks on the surface, the guides are placed on the surface at that position. The guide lines 232 can be repositioned as needed, and multiple sets of guides can be added to the same surface. By aligning these guide lines to controls on the surface, the software tester can determine if the controls are aligned with respect to one another. The guide lines remain on the surface and are included in the screenshot which is included in the reporting options described herein (report a defect, send an email, etc.), or they can be deleted.

As shown in FIG. 2C, the guide tool 221 illustrates that button 210C is not properly vertically aligned with buttons 210A and 210B. A gap 234 exists between an end of button 210C and the vertical line of the guide lines 232.

FIG. 2D shows a color picker tool 222 for detecting defects in a software application in accordance with an example embodiment. The color picker tool enables the software tester to detect the color of any point on the screen and to compare colors of two or more points on the screen. This comparison assists the software tester in determining if two or more colors are used consistently in different controls in application being tested.

To use the color picker tool 222, the software tester selects it from the toolbox and moves the cursor to the point whose color is being examined. An output (such as a balloon, box, window, text, etc.) is displayed above the cursor as it is being moved. This output indicates the color (e.g., a name of the color and/or the red, green, and blue (RGB) values) of the point under the cursor. For example, when the software tester clicks on the screen, the balloon is locked on that point with the RGB values displayed. By attaching RGB balloons to two or more points, the tester can check whether two or more points have the same color values. The RGB balloons remain on the surface and are included in the screenshot which is included in the reporting options described herein (report a defect, send an email, etc.), or they can be deleted.

As shown in FIG. 2D, a box 250A shows the RGB values for button 210A, and box 250B shows the RGB values for button 210B. These boxes indicate that box 250A has a different color than box 250B since the RGB values (250, 220, and 270) for button 210A are not equal to the RGB values (248, 220, and 250) for button 210B.

The grid tool 223 enables the tester to obtain a general view of object alignment in the tested application by displaying a grid on the screen. The spacing of the grid lines can be configured by the tester. The grid tool gives the software tester an overall view of the object alignment in the user interface of the software application being tested. If the software tester notices a potential alignment defect, the tester can then use the guide tool to more closely examine the defect, annotate it, and report it.

The spy tool 224 retrieves and displays the values of properties of objects and/or controls in the screen, such as coordinates and enable/disable status. To use the spy tool, the tester selects it from the toolbox and moves the cursor over the object whose properties are being viewed. The object in the screen is highlighted, and the properties of the object are displayed in a floating window above the object.

In one embodiment, while inspecting the software application, the software tester can zoom-in to and zoom-out from the inspection surface with the various set of inspection controls 215.

According to block 150, the detected defect is annotated.

The annotations tool 225 enables the software tester to graphically annotate the screen. The tool set includes: a rectangle tool and ellipse tool enabling the marking of screen areas; an arrow tool; a text box tool enabling the tester to add a text comment to the screenshot (e.g., a comment describing the defect); a highlighter tool enabling the tester to highlight areas or text in the screen. Screen annotations remain on the surface of the display and are included in the screenshot which is included in the reporting options described herein (report a defect, send an email, etc.), or they can be deleted.

According to block 160, the detected defect and corresponding annotation are reported and saved. By way of example, the software tester can perform one or more of the following:
1. Report the detected defect to a defect tracking system (e.g., the defect tracking system 370 in FIG. 3). In one embodiment, the defect automatically includes a screenshot of the current screen of the tested application and the accompanying annotations of the detected issues. For example, the defect includes a screenshot of FIGS. 2B-2D.
2. Transmit (directly from the testing surface) the screenshot with annotations as an attachment. For example, an email is sent to the developer to fix the defects or errors in the software application.
3. Save the annotated screenshot to a local or remote storage device or network location.
4. Print the annotated screenshot.
5. Save the annotated screenshot to the manual test's report. This way when going through the tests report, the reviewer can see the problem detected.

According to block 170, a determination is made as to whether to continue testing the application. If the answer to this determination is “no” then flow proceeds to block 190 and testing of the software application is finished. If the answer to this determination is “yes” then flow proceeds to block 180.

According to block 180, a move is made to the next user interface in the software application. For example, the software application advances to the next screen output, GUI, series of buttons/controls, etc. and flow loops back to block 130.

FIG. 3 shows a computer system 300 in accordance with an example embodiment. The computer system includes one or more computers or servers 305 coupled to one or more storage devices, storage mediums, databases, or warehouses 360 and defect tracking system 370. The computer 305 includes memory 310, a software application 320 (e.g., the software application being designed and/or tested in accordance with example embodiments), a display 330, a processor unit 340, a software testing application and inspection tools 350, and one or more buses, connections, or links 370. The processor unit includes a processor (such as a central processing unit, CPU, microprocessor, application-specific integrated circuit (ASIC), etc.) for controlling the overall operation of memory 310 (such as random access memory (RAM) for temporary data storage, read only memory (ROM) for permanent data storage, and firmware). The processing unit 340 communicates with memory 310 and applications 320 and 350 to perform operations and tasks necessary for executing the methods explained herein. The memory 310, for example, stores applications (such as applications 350 and 320), data, programs, algorithms (including software to implement or assist in implementing example embodiments) and other data.

In one example embodiment, the defect tracking system 370 is remotely located from the computer 305. For example, the defect tracking system stores the defects and/or provides the defects to software developers to cure or fix the detected defects in the software application.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments are provided as examples and should not be construed to limit other embodiments. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit example embodiments.

In some example embodiments, the methods illustrated herein and data and instructions associated therewith are stored in respective storage devices, which are implemented as one or more computer-readable or computer-usable storage media or mediums (such as shown at 360 in FIG. 3). The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

Example embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible computer-readable media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles of example embodiments. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
opening, on a display of a computer, a window that displays an inspection tool and output generated by a software application being tested for defects;
detecting, with the inspection tool, a defect in a user interface of the output of the software application; and
generating, in the window and with the inspection tool, an annotation of the defect.

2) The method of claim 1 further comprising:
generating a screenshot of the annotation;
transmitting the screenshot to a defect tracking system.

3) The method of claim 1 further comprising:
displaying a line between a starting point on a first control in the window and an ending point on a second control in the window;
measuring a distance between starting point and the ending point;
displaying the distance in the window.

4) The method of claim 1 further comprising:
displaying, in the window, vertical and horizontal guide lines that intersect each other;
positioning the vertical and horizontal guide lines at a location in the window indicated with a click.

5) The method of claim 1 further comprising:
displaying red, green, and blue (RGB) values adjacent a cursor as the cursor moves across the window;
locking an RGB value at a location in the window;
displaying the RGB value in the window.

6) The method of claim 1 further comprising, displaying, in the window and with the inspection tool, a grid that provides alignment of objects in the window.

7) The method of claim 1 further comprising, displaying, with the inspection tool, coordinates of an object located in the window as a cursor moves over the object.

8) The method of claim 1 further comprising, annotating, with the inspection tool, the window with text that describes the defect in the software application.

9) A tangible computer readable storage medium having instructions for causing a computer to execute a method, comprising:
executing a testing tool that examines a user interface of a software application for defects;
opening, in the testing tool, a set of inspection tools;
detecting the defects with the set of inspection tools;
annotating the defects with the set of inspection tools; and
reporting the defects and annotations to a defect tracking system.

10) The tangible computer readable storage medium of claim 9 further comprising, generating a screenshot of the defects and the annotations in response to detecting the defects.

11) The tangible computer readable storage medium of claim 9 further comprising, generating, with the set of inspection tools, a ruler line that displays a distance between two buttons that generated as output from the software application.

12) The tangible computer readable storage medium of claim 9 further comprising, generating, with the set of inspection tools, multiple sets of vertical and horizontal guide lines that illustrate whether objects output from the software application are properly aligned.

13) The tangible computer readable storage medium of claim 9 further comprising, generating, with the set of inspection tools, a value of a color being displayed at a location of a cursor.

14) The tangible computer readable storage medium of claim 9 further comprising:
generating, with the set of inspection tools, a highlight on one of the defects;
generating a snapshot of the highlight;
transmitting the snapshot to the defect tracking system.

15) A computer system, comprising:
a display;
a memory storing instructions; and
a processor executing the instructions to:
open, on the display, an inspection surface that displays an inspection tool and output generated by an executing software application that is being examined for defects;
detect, with the inspection tool, a defect in a user interface of the output of the software application; and
annotate, with the inspection tool, the defect.

16) The computer system of claim 15, wherein the processor further executes the instructions to lock a ruler line along a horizontal axis of the display and a vertical axis of the display upon receiving clicks from an input device.

17) The computer system of claim 15, wherein the processor further executes the instructions to:
generate a screenshot of the defect; and
transmit the screenshot in an email.

18) The computer system of claim 15, wherein the processor further executes the instructions to generate intersecting vertical and horizontal guide lines that move across the display to track movement of a cursor.

19) The computer system of claim 15, wherein the processor further executes the instructions to generate a ruler on the display that displays a measurement of a distance between a first point indicated with a first click and a second point indicated with a second click.

20) The computer system of claim 15, wherein the processor further executes the instructions to report the defect to a defect tracking system, wherein the defect automatically includes a snapshot of a current screen generated by the executing software application.
